(19) United States
(12) Patent Application Publication
(10) Pub. No.: US 2021/0208371 A1
(43) Pub. Date: Jul. 8, 2021

(54) OPTICAL IMAGING LENS ASSEMBLY

(71) Applicant: ZHEJIANG SUNNY OPTICS CO., LTD., Yuyao City (CN)

(72) Inventors: Rui ZHANG, Yuyao City (CN); Lingbo He, Yuyao City (CN); Fujian Dai, Yuyao City (CN); Liefeng Zhao, Yuyao City (CN)

(73) Assignee: ZHEJIANG SUNNY OPTICS CO., LTD., Yuyao City (CN)

(21) Appl. No.: 17/206,437

(22) Filed: Mar. 19, 2021

Related U.S. Application Data
(63) Continuation of application No. PCT/CN2020/082985, filed on Apr. 2, 2020.

(30) Foreign Application Priority Data
Jun. 17, 2019 (CN) 201910522371.9

(51) Int. Cl. G02B 13/00; G02B 9/60

(52) U.S. Cl. CPC G02B 13/0045; G02B 9/60

(57) ABSTRACT

The present disclosure discloses an optical imaging lens assembly including, sequentially from an object side to an image side along an optical axis, a first lens having positive refractive power; a second lens having negative refractive power and an aspheric image-side surface; a third lens having refractive power and a convex image-side surface; a fourth lens having refractive power; and a fifth lens having positive refractive power, a convex object-side surface and a concave image-side surface. The first lens and the second lens are cemented to form a cemented lens.

### CROSS-REFERENCE TO RELATED APPLICATION

The present patent application is a continuation of International Application No. PCT/CN2020/082985, filed on Apr. 2, 2020, which claims priority to Chinese Patent Application No. 201910522371.9, filed before the China National Intellectual Property Administration (CNIPA) on Jun. 17, 2019. Both of the aforementioned patent applications are hereby incorporated by reference in their entireties.

### TECHNICAL FIELD

The present disclosure relates to an optical imaging lens assembly, and specifically, relates to an optical imaging lens assembly including five lenses.

### BACKGROUND

With the continuous development of optical imaging lens assembly in various fields, people have put forward higher and higher requirements on the image quality of optical imaging lens assembly. Meanwhile, the trend toward ultra-thin portable electronic devices, such as mobile phones, also requires the lens assembly mounted thereon to be miniaturized. Generally speaking, reducing the lens aperture is an effective way to reduce the size of an optical imaging lens assembly. However, the image quality of the lens assembly, especially the detail performance ability, tends to deteriorate as the lens assembly aperture reduces. Therefore, how to improve the image quality while ensuring the miniaturization of the optical imaging lens assembly is a problem that needs to be solved urgently.

### SUMMARY

The present disclosure provides an optical imaging lens assembly that is applicable to portable electronic products and at least solves or partially solves at least one of the above disadvantages of the prior art.

In one aspect, the present disclosure provides an optical imaging lens assembly which may include, sequentially from an object side to an image side along an optical axis, a first lens having positive refractive power; a second lens having negative refractive power, and an image-side surface thereof may be aspheric; a third lens having refractive power and a convex image-side surface; a fourth lens having refractive power; and a fifth lens having positive refractive power, a convex object-side surface and a concave image-side surface.

In one embodiment, an effective focal length f1 of the first lens and a radius of curvature R1 of an object-side surface of the first lens may satisfy: 1.5<f1/R1<2.0.

In one embodiment, a combined focal length f12 of the first lens and the second lens and a total effective focal length f of the optical imaging lens assembly may satisfy: 0.5<f12/f<1.5.

In one embodiment, a center thickness CT1 of the first lens along the optical axis, a center thickness CT2 of the second lens along the optical axis and a center thickness CT3 of the third lens along the optical axis may satisfy: 1.0<(CT1+CT2)/CT3≤2.01.

In one embodiment, a center thickness CT5 of the fifth lens along the optical axis and a center thickness CT4 of the fourth lens along the optical axis may satisfy: 1.0<CT5/CT4<2.5.

In one embodiment, a spaced interval T34 between the third lens and the fourth lens along the optical axis and a spaced interval T23 between the second lens and the third lens along the optical axis may satisfy: 0.5<T34/T23<2.0.

In one embodiment, a maximum effective radius DT51 of the object-side surface of the fifth lens and a maximum effective radius DT11 of an object-side surface of the first lens may satisfy: 2.0<DT51/DT11<3.5.

In one embodiment, a center thickness CT1 of the first lens along the optical axis, a center thickness CT2 of the second lens along the optical axis, an edge thickness ET1 of the first lens and an edge thickness ET2 of the second lens may satisfy: 1.0<(CT1+CT2)/(ET1+ET2)<2.0.

In one embodiment, a radius of curvature R6 of the image-side surface of the third lens and a total effective focal length f of the optical imaging lens assembly may satisfy: −2.0<R6/f<−0.5.

In one embodiment, a radius of curvature R9 of the object-side surface of the fifth lens and a radius of curvature R10 of the image-side surface of the fifth lens may satisfy: 0.5<R9/R10<1.5.

In one embodiment, a maximum effective radius DT11 of an object-side surface of the first lens and a maximum effective radius DT22 of the image-side surface of the second lens may satisfy: (DT11+DT22)/2<0.9 mm.

In one embodiment, the first lens to the fifth lens are lenses made of plastic material.

The optical imaging lens assembly provided by the example of the present disclosure employs five lenses. The above optical imaging lens assembly has at least one beneficial effect, such as ultra-thinness, high image quality, and ease of processing and manufacturing and the like, by combining the first lens and the second lens as a cemented lens and rationally configuring the refractive power, the surface shape, the center thickness of each lens, and the on-axis spaced interval between the lenses and the like.

### BRIEF DESCRIPTION OF THE DRAWINGS

Other features, objects, and advantages of the present disclosure will become more apparent from the following detailed description of the non-limiting embodiments with reference to the accompanying drawings. In the drawings:

FIG. 1 illustrates a schematic structural view of an optical imaging lens assembly according to example 1 of the present disclosure;

FIGS. 2A to 2D illustrate longitudinal aberration curves, astigmatic curves, a distortion curve, and a lateral color curve of the optical imaging lens assembly of the example 1, respectively;

FIG. 3 illustrates a schematic structural view of an optical imaging lens assembly according to example 2 of the present disclosure;

FIGS. 4A to 4D illustrate longitudinal aberration curves, astigmatic curves, a distortion curve, and a lateral color curve of the optical imaging lens assembly of the example 2, respectively;

FIG. 5 illustrates a schematic structural view of an optical imaging lens assembly according to example 3 of the present disclosure;

FIGS. 6A to 6D illustrate longitudinal aberration curves, astigmatic curves, a distortion curve, and a lateral color curve of the optical imaging lens assembly of the example 3, respectively;

FIG. 7 illustrates a schematic structural view of an optical imaging lens assembly according to example 4 of the present disclosure;

FIGS. 8A to 8D illustrate longitudinal aberration curves, astigmatic curves, a distortion curve, and a lateral color curve of the optical imaging lens assembly of the example 4, respectively;

FIG. 9 illustrates a schematic structural view of an optical imaging lens assembly according to example 5 of the present disclosure;

FIGS. 10A to 10D illustrate longitudinal aberration curves, astigmatic curves, a distortion curve, and a lateral color curve of the optical imaging lens assembly of the example 5, respectively;

FIG. 11 illustrates a schematic structural view of an optical imaging lens assembly according to example 6 of the present disclosure;

FIGS. 12A to 12D illustrate longitudinal aberration curves, astigmatic curves, a distortion curve, and a lateral color curve of the optical imaging lens assembly of the example 6, respectively;

FIG. 13 illustrates a schematic structural view of an optical imaging lens assembly according to example 7 of the present disclosure;

FIGS. 14A to 14D illustrate longitudinal aberration curves, astigmatic curves, a distortion curve, and a lateral color curve of the optical imaging lens assembly of the example 7, respectively;

FIG. 15 illustrates a schematic structural view of an optical imaging lens assembly according to example 8 of the present disclosure; and

FIGS. 16A to 16D illustrate longitudinal aberration curves, astigmatic curves, a distortion curve, and a lateral color curve of the optical imaging lens assembly of the example 8, respectively.

### DETAILED DESCRIPTION OF EMBODIMENTS

For a better understanding of the present disclosure, various aspects of the present disclosure will be described in more detail with reference to the accompanying drawings. It should be understood that the detailed description is merely illustrative of the exemplary embodiments of the present disclosure and is not intended to limit the scope of the present disclosure in any way. Throughout the specification, the same reference numerals refer to the same elements. The expression “and/or” includes any and all combinations of one or more of the associated listed items.

It should be noted that in the present specification, the expressions such as first, second, third are used merely for distinguishing one feature from another, without indicating any limitation on the features. Thus, a first lens discussed below may also be referred to as a second lens or a third lens without departing from the teachings of the present disclosure.

In the accompanying drawings, the thickness, size and shape of the lens have been somewhat exaggerated for the convenience of explanation. In particular, shapes of spherical surfaces or aspheric surfaces shown in the accompanying drawings are shown by way of example. That is, shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, the paraxial area refers to an area near the optical axis. If a surface of a lens is convex and the position of the convex is not defined, it indicates that the surface of the lens is convex at least in the paraxial region; and if a surface of a lens is concave and the position of the concave is not defined, it indicates that the surface of the lens is concave at least in the paraxial region. In each lens, the surface closest to the object is referred to as an object-side surface of the lens, and the surface closest to the imaging plane is referred to as an image-side surface of the lens.

It should be further understood that the terms “comprising,” “including,” “having,” “containing” and/or “contain,” when used in the specification, specify the presence of stated features, elements and/or components, but do not exclude the presence or addition of one or more other features, elements, components and/or combinations thereof. In addition, expressions, such as “at least one of,” when preceding a list of features, modify the entire list of features rather than an individual element in the list. Further, the use of “may,” when describing embodiments of the present disclosure, refers to “one or more embodiments of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It will be further understood that terms, such as those defined in commonly used dictionaries, should be interpreted as having a meaning that is consistent with the meaning in the context of the relevant art and will not be interpreted in an idealized or overly formal sense, unless expressly so defined herein.

It should also be noted that, the examples in the present disclosure and the features in the examples may be combined with each other on a non-conflict basis. The present disclosure will be described in detail below with reference to the accompanying drawings and in combination with the examples.

The features, principles, and other aspects of the present disclosure are described in detail below.

As portable electronic devices, such as mobile phones, continue to become ultra-thin, the lens assemblies mounted on the portable electronic devices are becoming more and more miniaturized. Generally, the size of the optical imaging lens assembly is reduced by reducing the lens aperture. However, the image quality of the lens assembly, especially the detail performance ability, tends to deteriorate as the lens assembly aperture reduces. Therefore, the present disclosure provides an optical imaging lens assembly that may improve the image quality while ensuring the miniaturization of the optical imaging lens assembly.

An optical imaging lens assembly according to an exemplary embodiment of the present disclosure may include, for example, five lenses having refractive power, that is, a first lens, a second lens, a third lens, a fourth lens and a fifth lens. The five lenses are arranged sequentially from an object side to an image side along an optical axis.

In an exemplary embodiment, the first lens may have positive refractive power; the second lens may have negative refractive power, and an image-side surface thereof may be aspheric; the third lens has positive or negative refractive power, and an image-side surface thereof may be convex; the fourth lens has positive or negative refractive power; and the fifth lens may have positive refractive power, an object-side surface thereof may be convex, and an image-side surface thereof may be concave.

By reasonably configuring the refractive power of the first lens, it is possible to ensure that the first lens has good workability, and to shorten the total length of the optical imaging lens assembly so as to make the structure of the lens assembly compact. By reasonably configuring the refractive power of the second lens, it may be beneficial to correct the off-axis aberration of the optical lens assembly, thereby improving the image quality. By configuring the image-side surface of the second lens as an aspheric surface, the spherical aberration of the optical imaging lens assembly may be corrected to obtain an improved image quality. By reasonably controlling the shape of the third lens and configuring the image-side surface of the third lens as a convex surface, the tolerance sensitivity of the lens assembly may be effectively reduced. By reasonably configuring the refractive power and the shape of the fifth lens, it is beneficial to ensure that the chief ray of the optical imaging lens assembly has a small incident angle when the chief ray is incident on the image plane, so as to improve the relative illumination on the image plane.

In an exemplary embodiment, the first lens and the second lens may be cemented to form a cemented lens. Using the cemented lens is not only helps to eliminate the chromatic aberration of the first lens and the second lens of the cemented lens, but also compensates the overall chromatic aberration of the lens system by the residual partial chromatic aberration, so as to enhance the system's ability to compensate chromatic aberration and improve imaging resolution. At the same time, the cementing of the lenses omits the air interval between the two lenses, making the overall structure of the lens assembly compact, which is beneficial to shorten the total optical length of the lens assembly to meet the requirements of miniaturization. In addition, the cementing of the lenses will reduce the tolerance sensitivity issues such as tilt and eccentricity of the lens unit during the assembly process, so as to improve the mass production of the lens assembly. At the same time, the cemented lens also has the advantages of low light energy loss and high resolution in the lateral and axial directions.

In an exemplary embodiment, all lenses in the optical imaging lens assembly of the present disclosure are made of plastic materials. The use of plastic lenses may effectively reduce costs and reduce the difficulty of lens processing.

In an exemplary embodiment, the optical imaging lens assembly according to the present disclosure may satisfy: 1.5<f1/R1<2.0, where f1 is an effective focal length of the first lens, and R1 is a radius of curvature of an object-side surface of the first lens. More specifically, f1 and R1 may further satisfy: 1.69≤f1/R1≤1.99. By reasonably controlling the ratio of the effective focal length of the first lens to the radius of curvature of the object-side surface of the first lens, the field curvature contributed by the first lens may be controlled within a reasonable range, and the optical sensitivity of the object-side surface of the first lens may be reduced.

In an exemplary embodiment, the optical imaging lens assembly according to the present disclosure may satisfy: 0.5<f12/f<1.5, where f12 is a combined focal length of the first lens and the second lens, and f is a total effective focal length of the optical imaging lens assembly. More specifically, f12 and f may further satisfy: 0.96≤f12/f≤1.32. By reasonably controlling the ratio of the combined focal length of the first lens and the second lens to the effective focal length of the optical imaging lens assembly, the chromatic aberration of the optical imaging lens assembly may be effectively reduced, thereby avoiding the spherical aberration and coma aberration of the optical imaging lens assembly being excessive large.

In an exemplary embodiment, the optical imaging lens assembly according to the present disclosure may satisfy: 1.0<(CT1+CT2)/CT3<2.01, where CT1 is a center thickness of the first lens along the optical axis, CT2 is a center thickness of the second lens along the optical axis, and CT3 is a center thickness of the third lens along the optical axis. More specifically, CT1, CT2 and CT3 may further satisfy: 1.30≤(CT1+CT2)/CT3≤2.01. By reasonably controlling the ratio of the entire center thickness of the cemented lens to the center thickness of the third lens, the thickness sensitivity of the lens assembly may be effectively reduced, which is beneficial to correct the chromatic aberration of the optical system.

In an exemplary embodiment, the optical imaging lens assembly according to the present disclosure may satisfy: 1.0<CT5/CT4<2.5, where CT5 is a center thickness of the fifth lens along the optical axis, and CT4 is a center thickness of the fourth lens along the optical axis. More specifically, CT5 and CT4 may further satisfy: 1.30≤CT5/CT4≤2.15. By reasonably distributing the center thicknesses of the fifth lens and the fourth lens, the lenses are easy to be injection molded, the workability of the optical imaging lens assembly is improved, and the better image quality is ensured.

In an exemplary embodiment, the optical imaging lens assembly according to the present disclosure may satisfy: 0.5<T34/T23<2.0, where T34 is a spaced interval between the third lens and the fourth lens along the optical axis, and T23 is a spaced interval between the second lens and the third lens along the optical axis. More specifically, T34 and T23 may further satisfy: 0.63≤T34/T23≤1.82. By reasonably controlling the ratio of T34 to T23, it is beneficial to reduce the thickness sensitivity of the lens assembly so as to meet the requirements of miniaturization and processability for the lens assembly.

In an exemplary embodiment, the optical imaging lens assembly according to the present disclosure may satisfy: 2.0<DT51/DT11<3.5, where DT51 is a maximum effective radius of the object-side surface of the fifth lens, and DT11 is a maximum effective radius of an object-side surface of the first lens. More specifically, DT51 and DT11 may further satisfy: 2.30≤DT51/DT11≤3.06. By reasonably controlling the maximum effective radii of the object-side surface of the fifth lens and the image-side surface of the first lens, the structure feasibility of the lens assembly may be better ensured, thereby reducing the difficulty of assembly. At the same time, it is beneficial to achieve the miniaturization of the lens assembly.

In an exemplary embodiment, the optical imaging lens assembly according to the present disclosure may satisfy: 1.0<(CT1+CT2)/(ET1+ET2)<2.0, where CT1 is a center thickness of the first lens along the optical axis, CT2 is a center thickness of the second lens along the optical axis, ET1 is an edge thickness of the first lens in a direction parallel to the optical axis, and ET2 is an edge thickness of the second lens in a direction parallel to the optical axis. More specifically, CT1, CT2, ET1 and ET2 may further satisfy: 1.27≤(CT1+CT2)/(ET1+ET2)≤1.56. By reasonably controlling the ratio of the sum of the center thicknesses of the first lens and the second lens to the sum of the edge thicknesses of the first lens and the second lens, the processing difficulty of the lenses may be reduced. At the same time, the spherical aberration and chromatic aberration of the optical system is advantageously corrected.

In an exemplary embodiment, the optical imaging lens assembly according to the present disclosure may satisfy: −2.0<R6/f<−0.5, where R6 is a radius of curvature of the image-side surface of the third lens, and f is a total effective focal length of the optical imaging lens assembly. More specifically, R6 and f may further satisfy: −1.72≤R6/f≤−0.92. By reasonably controlling the ratio of the radius of curvature of the image-side surface of the third lens to the effective focal length of the optical system, the resolution of the lens assembly may be effectively improved and the relative illumination on the image plane may be improved.

In an exemplary embodiment, the optical imaging lens assembly according to the present disclosure may satisfy: 0.5<R9/R10<1.5, where R9 is a radius of curvature of the object-side surface of the fifth lens, and R10 is a radius of curvature of the image-side surface of the fifth lens. More specifically, R9 and R10 may further satisfy: 0.94≤R9/R10≤1.20. By reasonably controlling the ratio of the radii of curvature of the object-side surface and the image-side surface of the fifth lens, it is beneficial to ensure that the fifth lens has proper positive refractive power, while reducing the angle between the chief ray incident on the imaging plane and the optical axis and increasing the illumination on the imaging plane.

In an exemplary embodiment, the optical imaging lens assembly according to the present disclosure may satisfy: (DT11+DT22)/2<0.9 mm, where DT11 is a maximum effective radius of an object-side surface of the first lens, and DT22 is a maximum effective radius of the image-side surface of the second lens. More specifically, DT11 and DT22 may further satisfy: 0.79 mm≤(DT11+DT22)/2≤0.87 mm. By reasonably controlling the maximum effective radius of the object-side surface of the first lens and the maximum effective half-aperture of the image-side surface of the second lens, it is beneficial to achieve the miniaturization of the system.

In an exemplary embodiment, the above optical imaging lens assembly may further include a stop. The stop may be disposed at an appropriate position as required, for example, between the object side and the first lens. Optionally, the above optical imaging lens assembly further includes an optical filter for correcting the color deviation and/or a protective glass for protecting the photosensitive element located on an imaging plane.

In an exemplary embodiment, the image-side surface of the second lens in the optical imaging lens assembly of the present disclosure is aspheric. The aspheric lens is characterized by a continuous change in curvature from the center of the lens to the periphery of the lens. Unlike a spherical lens having a constant curvature from the center of the lens to the periphery of the lens, the aspheric lens has a better curvature radius characteristic, and has the advantages of improving distortion aberration and improving astigmatic aberration. With aspheric lens, the aberrations that occur during imaging may be eliminated as much as possible, and thus improving the image quality. Optionally, at least one of the object-side surface and the image-side surface of each of the first lens, the second lens, the third lens, the fourth lens and the fifth lens is aspheric. Optionally, the object-side surface and the image-side surface of each of the first lens, the second lens, the third lens, the fourth lens and the fifth lens are aspheric.

Exemplary embodiments of the present disclosure also provide a camera apparatus including the above-described optical imaging lens assembly.

Exemplary embodiments of the present disclosure also provide an electronic device including the above-described camera apparatus.

However, it will be understood by those skilled in the art that the number of lenses constituting the optical imaging lens assembly may be varied to achieve the various results and advantages described in this specification without departing from the technical solution claimed by the present disclosure. For example, although the embodiment is described by taking five lenses as an example, the optical imaging lens assembly is not limited to include five lenses. The optical imaging lens assembly may also include other numbers of lenses if desired.

Some specific examples of an optical imaging lens assembly applicable to the above embodiment will be further described below with reference to the accompanying drawings.

### Example 1

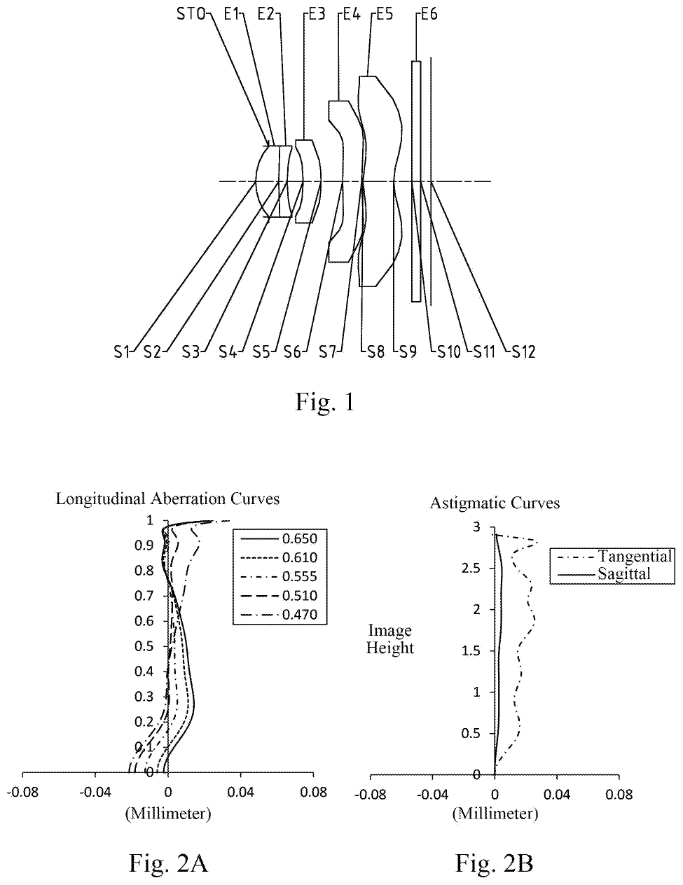

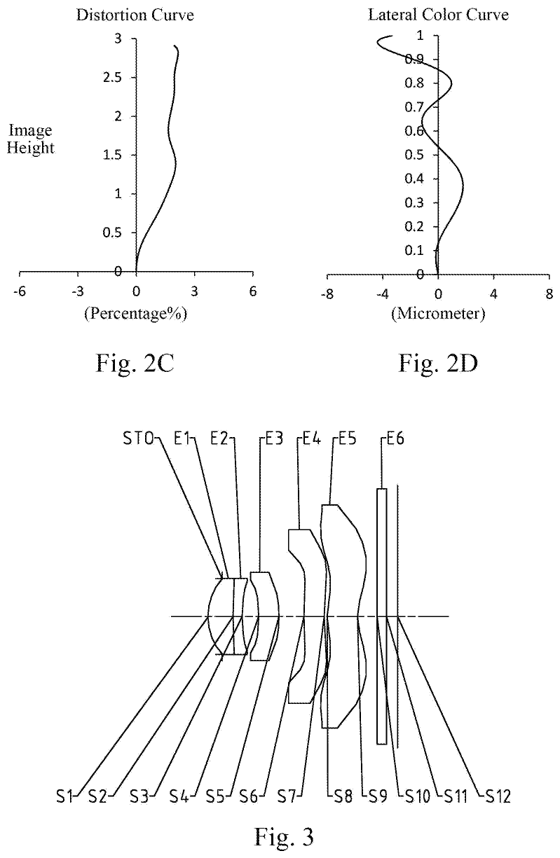

An optical imaging lens assembly according to example 1 of the present disclosure is described below with reference to FIG. 1 to FIG. 2D. FIG. 1 shows a schematic structural view of the optical imaging lens assembly according to example 1 of the present disclosure.

As shown in FIG. 1, the optical imaging lens assembly includes a stop STO, a first lens E1, a second lens E2, a third lens E3, a fourth lens E4, a fifth lens E5, an optical filter E6 and an imaging plane S12, which are sequentially arranged from an object side to an image side along an optical axis.

The first lens E1 has positive refractive power, an object-side surface S1 thereof is convex, and an image-side surface S2 thereof is concave. The second lens E2 has negative refractive power, an object-side surface S2 thereof is convex, and an image-side surface S3 thereof is concave. The third lens E3 has positive refractive power, an object-side surface S4 thereof is concave, and an image-side surface S5 thereof is convex. The fourth lens E4 has negative refractive power, an object-side surface S6 thereof is concave, and an image-side surface S7 thereof is concave. The fifth lens E5 has positive refractive power, an object-side surface S8 thereof is convex, and an image-side surface S9 thereof is concave. The optical filter E6 has an object-side surface S10 and an image-side surface S11. Light from an object sequentially passes through the respective surfaces S1 to S11 and is finally imaged on the imaging plane S12. In this example, the first lens and the second lens are combined into a cemented lens, and the image-side surface of the first lens is the object-side surface of the second lens.

Table 1 is a table illustrating basic parameters of the optical imaging lens assembly of example 1, wherein the units for the radius of curvature, the thickness/distance and the focal length are millimeter (mm).

TABLE 1

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.3090 | | | | |
| S1 | Aspheric | 1.3229 | 0.5512 | 1.55 | 56.1 | 2.31 | 0.0999 |
| S2 | Aspheric | 5.5675 | 0.2000 | 1.68 | 19.2 | −5.46 | 6.9641 |
| S3 | Aspheric | 3.2695 | 0.3820 | | | | 1.6508 |
| S4 | Aspheric | −4.1521 | 0.4285 | 1.55 | 56.1 | 29.12 | 19.2012 |
| S5 | Aspheric | −3.4123 | 0.5165 | | | | 10.2573 |
| S6 | Aspheric | −15.7501 | 0.4527 | 1.68 | 19.2 | −8.08 | 86.3809 |
| S7 | Aspheric | 8.4910 | 0.0300 | | | | −28.9266 |
| S8 | Aspheric | 1.3089 | 0.7323 | 1.55 | 56.1 | 18.27 | −8.9266 |
| S9 | Aspheric | 1.2089 | 0.4350 | | | | −1.5490 |
| S10 | Spherical | Infinite | 0.2100 | 1.52 | 64.2 | | |
| S11 | Spherical | Infinite | 0.2586 | | | | |
| S12 | Spherical | Infinite | | | | | |

In this example, a total effective focal length f of the optical imaging lens assembly satisfies f=3.41 mm, a distance TTL along the optical axis from the object-side surface S1 of the first lens E1 to the imaging plane S12 satisfies TTL=4.20 mm, half of a diagonal length ImgH of an effective pixel area on the imaging plane S12 satisfies ImgH=2.91 mm, half of a maximum field-of-view Semi-FOV of the optical imaging lens assembly satisfies Semi-FOV=39.9°, and an aperture number Fno of the optical imaging lens assembly satisfies Fno=2.04.

In example 1, the object-side surface and the image-side surface of any one of the first lens E1 to the fifth lens E5 are aspheric. The surface shape x of each aspheric lens may be defined by using, but not limited to, the following aspheric formula:

$$x = \frac{c {h}^{2}}{1 + \sqrt{1 - ( k + 1 ) {c}^{2} {h}^{2}}} + \sum {Aih}^{i} \qquad ( 1 )$$

Where, x is the sag—the axis-component of the displacement of the surface from the aspheric vertex, when the surface is at height h from the optical axis; c is a paraxial curvature of the aspheric surface, c=1/R (that is, the paraxial curvature c is reciprocal of the radius of curvature R in the above Table 1); k is a conic coefficient; Ai is a correction coefficient for the i-th order of the aspheric surface. Table 2 below shows high-order coefficients A4, A6, A8, A10, A12, A14, A16, A18 and A20 applicable to each aspheric surface S1 to S9 in example 1.

TABLE 2

| Sur- | | | | | | | | | |
|---|---|---|---|---|---|---|---|---|---|
| face | | | | | | | | | |
| num- | A4 | A6 | A8 | A10 | Al2 | A14 | A16 | A18 | A20 |
| ber | | | | | | | | | |
| S1 | −1.8806E − | 4.4765E − | −3.7730E + | 2.0031E + | −6.6341E + | 1.3793E + | −1.7431E + | 1.2220E + | −3.6417E + |
| | 02 | 01 | 00 | 01 | 01 | 02 | 02 | 02 | 01 |
| S2 | −1.6732E − | 6.0194E − | −4.9362E + | 2.1718E + | −5.3590E + | 7.2692E + | −4.3744E + | −7.3767E − | 8.5694E + |
| | 01 | 01 | 00 | 01 | 01 | 01 | 01 | 01 | 00 |
| S3 | −3.6698E − | 2.2404E − | −3.4943E − | −4.6237E − | −1.0715E + | 1.1927E + | −3.7300E + | 5.0507E + | −2.4967E + |
| | 03 | 02 | 02 | 02 | 00 | 01 | 01 | 01 | 01 |
| S4 | −1.4326E − | 2.0086E − | −3.9622E + | 2.6152E + | −1.0182E + | 2.4385E + | −3.5523E + | 2.9143E + | −1.0295E + |
| | 01 | 01 | 00 | 01 | 02 | 02 | 02 | 02 | 02 |
| S5 | −4.1245E − | −3.4198E − | 1.3922E + | −5.0527E + | 1.3314E + | −2.2257E + | 2.2609E + | −1.2564E + | 2.9745E + |
| | 02 | 01 | 00 | 00 | 01 | 01 | 01 | 01 | 00 |
| S6 | 3.1042E − | −7.2639E − | 1.2819E + | −1.9998E + | 2.1377E + | −1.4656E + | 6.0787E − | −1.3659E − | 1.2631E − |
| | 01 | 01 | 00 | 00 | 00 | 00 | 01 | 01 | 02 |
| S7 | −1.9777E − | 7.6080E − | −1.2632E + | 1.1547E + | −6.6274E − | 2.4320E − | −5.4989E − | 6.9483E − | −3.7460E − |
| | 01 | 01 | 00 | 00 | 01 | 01 | 02 | 03 | 04 |
| S8 | −4.1262E − | 5.4614E − | −5.0186E − | 2.8983E − | −1.0377E − | 2.3198E − | −3.1650E − | 2.4171E − | −7.9346E − |
| | 01 | 01 | 01 | 01 | 01 | 02 | 03 | 04 | 06 |
| S9 | −3.3813E − | 2.3623E − | −1.1183E − | 2.5332E − | 1.2627E − | −2.1120E − | 4.8662E − | −4.8721E − | 1.8671E − |
| | 01 | 01 | 01 | 02 | 03 | 03 | 04 | 05 | 06 |

FIG. 2A illustrates longitudinal aberration curves of the optical imaging lens assembly according to example 1, representing the deviations of focal points converged by light of different wavelengths after passing through the lens assembly. FIG. 2B illustrates astigmatic curves of the optical imaging lens assembly according to example 1, representing the curvatures of a tangential plane and the curvatures of a sagittal plane. FIG. 2C illustrates a distortion curve of the optical imaging lens assembly according to example 1, representing the amounts of distortion corresponding to different image heights. FIG. 2D illustrates a lateral color curve of the optical imaging lens assembly according to example 1, representing the deviations of different image heights on an imaging plane after light passes through the lens assembly. It can be seen from FIG. 2A to FIG. 2D that the optical imaging lens assembly provided in example 1 may achieve good image quality.

### Example 2

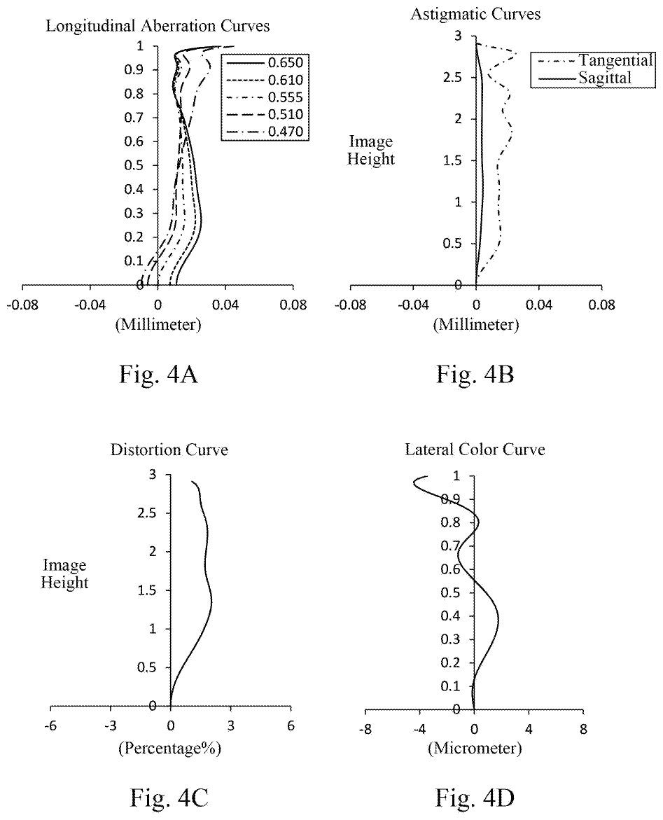

An optical imaging lens assembly according to example 2 of the present disclosure is described below with reference to FIG. 3 to FIG. 4D. FIG. 3 shows a schematic structural view of the optical imaging lens assembly according to example 2 of the present disclosure.

As shown in FIG. 3, the optical imaging lens assembly includes a stop STO, a first lens E1, a second lens E2, a third lens E3, a fourth lens E4, a fifth lens E5, an optical filter E6 and an imaging plane S12, which are sequentially arranged from an object side to an image side along an optical axis.

The first lens E1 has positive refractive power, an object-side surface S1 thereof is convex, and an image-side surface S2 thereof is concave. The second lens E2 has negative refractive power, an object-side surface S2 thereof is convex, and an image-side surface S3 thereof is concave. The third lens E3 has positive refractive power, an object-side surface S4 thereof is concave, and an image-side surface S5 thereof is convex. The fourth lens E4 has negative refractive power, an object-side surface S6 thereof is convex, and an image-side surface S7 thereof is concave. The fifth lens E5 has positive refractive power, an object-side surface S8 thereof is convex, and an image-side surface S9 thereof is concave. The optical filter E6 has an object-side surface S10 and an image-side surface S11. Light from an object sequentially passes through the respective surfaces S1 to S11 and is finally imaged on the imaging plane S12. In this example, the first lens and the second lens are combined into a cemented lens, and the image-side surface of the first lens is the object-side surface of the second lens.

In this example, a total effective focal length f of the optical imaging lens assembly satisfies f=3.44 mm, a distance TTL along the optical axis from the object-side surface S1 of the first lens E1 to the imaging plane S12 satisfies TTL=4.21 mm, half of a diagonal length ImgH of an effective pixel area on the imaging plane S12 satisfies ImgH=2.91 mm, half of a maximum field-of-view Semi-FOV of the optical imaging lens assembly satisfies Semi-FOV=39.9°, and an aperture number Fno of the optical imaging lens assembly satisfies Fno=2.04.

Table 3 is a table illustrating basic parameters of the optical imaging lens assembly of example 2, wherein the units for the radius of curvature, the thickness/distance and the focal length are millimeter (mm).

TABLE 3

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.3124 | | | | |
| S1 | Aspheric | 1.3324 | 0.5561 | 1.55 | 56.1 | 2.33 | 0.0984 |
| S2 | Aspheric | 5.5566 | 0.2000 | 1.68 | 19.2 | −5.40 | 5.7666 |
| S3 | Aspheric | 3.2351 | 0.3671 | | | | 1.1442 |
| S4 | Aspheric | −3.9869 | 0.4482 | 1.55 | 56.1 | 23.56 | 16.7888 |
| S5 | Aspheric | −3.1643 | 0.5527 | | | | 8.6149 |
| S6 | Aspheric | 50.0000 | 0.4489 | 1.68 | 19.2 | −8.83 | 99.0000 |
| S7 | Aspheric | 5.3238 | 0.0654 | | | | −1.8357 |
| S8 | Aspheric | 1.3267 | 0.6719 | 1.55 | 56.1 | 31.54 | −8.5894 |
| S9 | Aspheric | 1.1804 | 0.4324 | | | | −3.7322 |
| S10 | Spherical | Infinite | 0.2100 | 1.52 | 64.2 | | |
| S11 | Spherical | Infinite | 0.2560 | | | | |
| S12 | Spherical | Infinite | | | | | |

In example 2, the object-side surface and the image-side surface of any one of the first lens E1 to the fifth lens E5 are aspheric. Table 4 below shows high-order coefficients A4, A6, A8, A10, A12, A14, A16, A18 and A20 applicable to each aspheric surface S1 to S9 in example 2.

TABLE 4

| Surface | | | | | | | | | |
|---|---|---|---|---|---|---|---|---|---|
| number | A4 | A6 | A8 | A10 | A12 | A14 | A16 | A18 | A20 |
| S1 | −1.6047E−02 | 4.0319E−01 | −3.3569E+00 | 1.7615E+01 | −5.7543E+01 | 1.1790E+02 | −1.4672E+02 | 1.0126E+02 | −2.9697E+01 |
| S2 | −1.5104E−01 | 3.4531E−01 | −2.4891E+00 | 7.9231E+00 | −6.3707E+00 | −2.6589E+01 | 8.0860E+01 | −8.6024E+01 | 3.2979E+01 |
| S3 | −4.8796E−03 | 7.7546E−02 | −7.8083E−01 | 5.2316E+00 | −2.3340E+01 | 6.8737E+01 | −1.2339E+02 | 1.2158E+02 | −4.9510E+01 |
| S4 | −1.4209E−01 | 2.4690E−01 | −4.2927E+00 | 2.8610E+01 | −1.1425E+02 | 2.8080E+02 | −4.1777E+02 | 3.4695E+02 | −1.2294E+02 |
| S5 | −4.9155E−02 | −2.7307E−01 | 1.2260E+00 | −4.5133E+00 | 1.1866E+01 | −1.9819E+01 | 2.0234E+01 | −1.1365E+01 | 2.7364E+00 |
| S6 | 1.9962E−01 | −4.9565E−01 | 8.8982E−01 | −1.4644E+00 | 1.6115E+00 | −1.1184E+00 | 4.6430E−01 | −1.0374E−01 | 9.5150E−03 |
| S7 | −2.2546E−01 | 6.7368E−01 | −1.0495E+00 | 9.2579E−01 | −5.1595E−01 | 1.8395E−01 | −4.0378E−02 | 4.9485E−03 | −2.5859E−04 |
| S8 | −4.0243E−01 | 4.3397E−01 | −3.4078E−01 | 1.8126E−01 | −6.1850E−02 | 1.3355E−02 | −1.7696E−03 | 1.3158E−04 | −4.2102E−06 |
| S9 | −2.0517E−01 | 1.2590E−01 | −4.8051E−02 | 9.5317E−04 | 7.3018E−03 | −3.0526E−03 | 5.7270E−04 | −5.2696E−05 | 1.9273E−06 |

FIG. 4A illustrates longitudinal aberration curves of the optical imaging lens assembly according to example 2, representing the deviations of focal points converged by light of different wavelengths after passing through the lens assembly. FIG. 4B illustrates astigmatic curves of the optical imaging lens assembly according to example 2, representing the curvatures of a tangential plane and the curvatures of a sagittal plane. FIG. 4C illustrates a distortion curve of the optical imaging lens assembly according to example 2, representing the amounts of distortion corresponding to different image heights. FIG. 4D illustrates a lateral color curve of the optical imaging lens assembly according to example 2, representing the deviations of different image heights on an imaging plane after light passes through the lens assembly. It can be seen from FIG. 4A to FIG. 4D that the optical imaging lens assembly provided in example 2 may achieve good image quality.

### Example 3

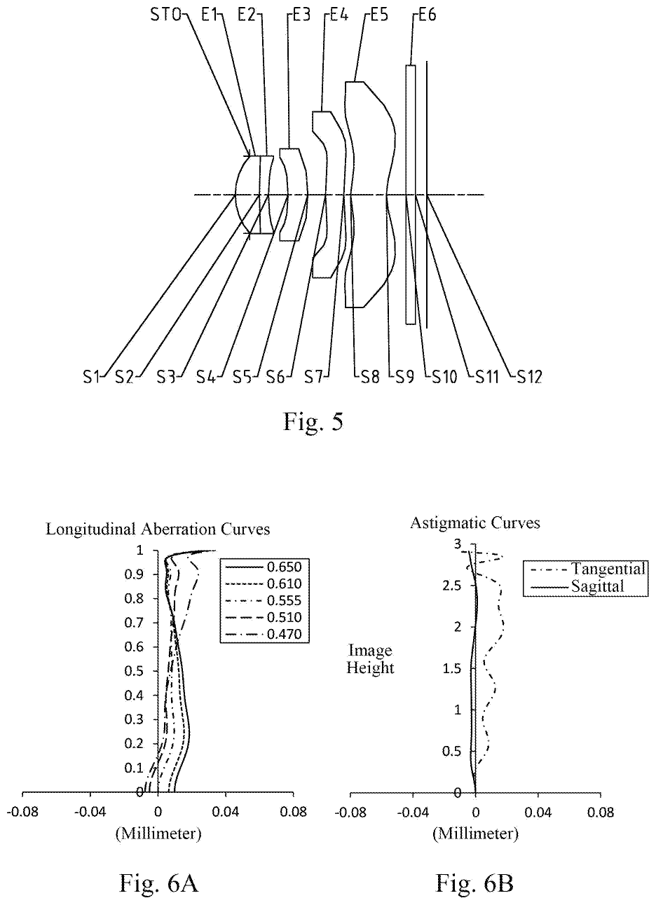

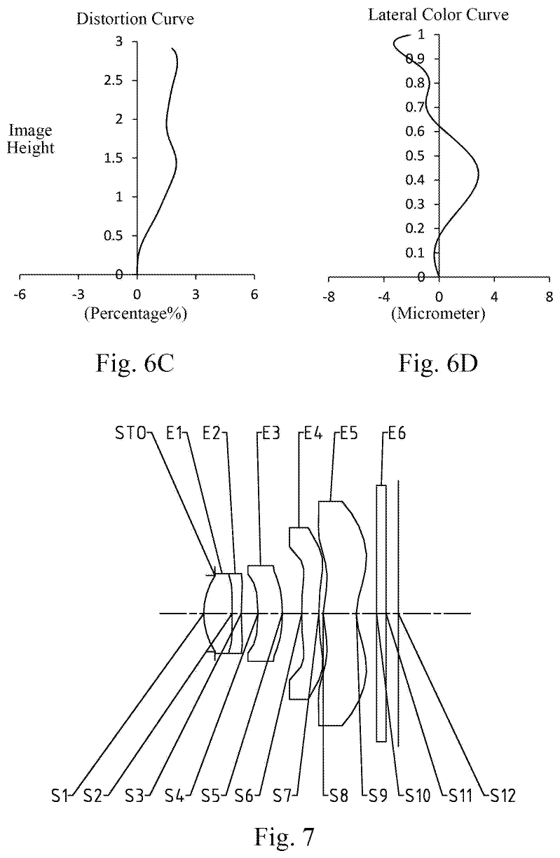

An optical imaging lens assembly according to example 3 of the present disclosure is described below with reference to FIG. 5 to FIG. 6D. FIG. 5 shows a schematic structural view of the optical imaging lens assembly according to example 3 of the present disclosure.

As shown in FIG. 5, the optical imaging lens assembly includes a stop STO, a first lens E1, a second lens E2, a third lens E3, a fourth lens E4, a fifth lens E5, an optical filter E6 and an imaging plane S12, which are sequentially arranged from an object side to an image side along an optical axis.

The first lens E1 has positive refractive power, an object-side surface S1 thereof is convex, and an image-side surface S2 thereof is concave. The second lens E2 has negative refractive power, an object-side surface S2 thereof is convex, and an image-side surface S3 thereof is concave. The third lens E3 has negative refractive power, an object-side surface S4 thereof is concave, and an image-side surface S5 thereof is convex. The fourth lens E4 has negative refractive power, an object-side surface S6 thereof is convex, and an image-side surface S7 thereof is concave. The fifth lens E5 has positive refractive power, an object-side surface S8 thereof is convex, and an image-side surface S9 thereof is concave. The optical filter E6 has an object-side surface S10 and an image-side surface S11. Light from an object sequentially passes through the respective surfaces S1 to S11 and is finally imaged on the imaging plane S12. In this example, the first lens and the second lens are combined into a cemented lens, and the image-side surface of the first lens is the object-side surface of the second lens.

In this example, a total effective focal length f of the optical imaging lens assembly satisfies f=3.47 mm, a distance TTL along the optical axis from the object-side surface S1 of the first lens E1 to the imaging plane S12 satisfies TTL=4.24 mm, half of a diagonal length ImgH of an effective pixel area on the imaging plane S12 satisfies ImgH=2.91 mm, half of a maximum field-of-view Semi-FOV of the optical imaging lens assembly satisfies Semi-FOV=39.5°, and an aperture number Fno of the optical imaging lens assembly satisfies Fno=2.04.

Table 5 is a table illustrating basic parameters of the optical imaging lens assembly of example 3, wherein the units for the radius of curvature, the thickness/distance and the focal length are millimeter (mm).

TABLE 5

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.3163 | | | | |
| S1 | Aspheric | 1.3406 | 0.5331 | 1.55 | 56.1 | 2.35 | 0.0873 |
| S2 | Aspheric | 6.3803 | 0.2000 | 1.68 | 19.2 | −5.91 | 12.5862 |
| S3 | Aspheric | 3.5626 | 0.4334 | | | | 1.7685 |
| S4 | Aspheric | −4.1620 | 0.4378 | 1.55 | 56.1 | −98.93 | 13.5841 |
| S5 | Aspheric | −4.6770 | 0.3931 | | | | 18.7976 |
| S6 | Aspheric | 6.7000 | 0.4038 | 1.68 | 19.2 | −7.04 | −85.0736 |
| S7 | Aspheric | 2.7174 | 0.1516 | | | | −65.8886 |
| S8 | Aspheric | 1.2204 | 0.7898 | 1.55 | 56.1 | 8.22 | −8.2955 |
| S9 | Aspheric | 1.2932 | 0.4335 | | | | −1.0768 |
| S10 | Spherical | Infinite | 0.2100 | 1.52 | 64.2 | | |
| S11 | Spherical | Infinite | 0.2570 | | | | |
| S12 | Spherical | Infinite | | | | | |

In example 3, the object-side surface and the image-side surface of any one of the first lens E1 to the fifth lens E5 are aspheric. Table 6 below shows high-order coefficients A4, A6, A8, A10, A12, A14, A16, A18 and A20 applicable to each aspheric surface S1 to S9 in example 3.

TABLE 6

| Surface | | | | | | | | | |
|---|---|---|---|---|---|---|---|---|---|
| number | A4 | A6 | A8 | A10 | A12 | A14 | A16 | A18 | A20 |
| S1 | −1.1649E−02 | 3.3458E−01 | −2.7094E+00 | 1.4045E+01 | −4.5436E+01 | 9.2338E+01 | −1.1402E+02 | 7.8085E+01 | −2.2728E+01 |
| S2 | −1.6329E−01 | 6.5798E−01 | −5.9308E+00 | 2.9804E+01 | −8.9730E+01 | 1.6850E+02 | −1.9301E+02 | 1.2448E+02 | −3.4809E+01 |
| S3 | −7.8513E−03 | 1.0921E−01 | −9.7214E−01 | 5.6559E+00 | −2.0833E+01 | 5.1755E+01 | −8.1480E+01 | 7.2955E+01 | −2.7686E+01 |
| S4 | −1.3866E−01 | −1.1183E−01 | 2.1239E−01 | −1.4211E+00 | 5.8665E+00 | −1.3683E+01 | 1.6164E+01 | −6.0894E+00 | −1.4463E+00 |
| S5 | −1.1097E−01 | −3.4709E−02 | 1.7108E−01 | −1.4968E+00 | 5.4991E+00 | −1.0143E+01 | 1.0455E+01 | −5.6503E+00 | 1.2700E+00 |
| S6 | −3.2219E−02 | 3.3345E−01 | −1.0293E+00 | 1.5665E+00 | −1.6917E+00 | 1.2785E+00 | −6.2751E−01 | 1.7707E−01 | −2.1466E−02 |
| S7 | −3.1836E−01 | 9.8896E−01 | −1.5123E+00 | 1.3346E+00 | −7.5488E−01 | 2.7831E−01 | −6.4440E−02 | 8.4787E−03 | −4.8255E−04 |
| S8 | −4.6512E−01 | 5.8299E−01 | −4.9197E−01 | 2.6747E−01 | −9.2170E−02 | 2.0097E−02 | −2.6963E−03 | 2.0367E−04 | −6.6432E−06 |
| S9 | −3.3633E−01 | 2.1721E−01 | −1.0137E−01 | 2.5617E−02 | −1.6309E−03 | −8.1106E−04 | 2.2614E−04 | −2.3491E−05 | 9.0561E−07 |

FIG. 6A illustrates longitudinal aberration curves of the optical imaging lens assembly according to example 3, representing the deviations of focal points converged by light of different wavelengths after passing through the lens assembly. FIG. 6B illustrates astigmatic curves of the optical imaging lens assembly according to example 3, representing the curvatures of a tangential plane and the curvatures of a sagittal plane. FIG. 6C illustrates a distortion curve of the optical imaging lens assembly according to example 3, representing the amounts of distortion corresponding to different image heights. FIG. 6D illustrates a lateral color curve of the optical imaging lens assembly according to example 3, representing the deviations of different image heights on an imaging plane after light passes through the lens assembly. It can be seen from FIG. 6A to FIG. 6D that the optical imaging lens assembly provided in example 3 may achieve good image quality.

### Example 4

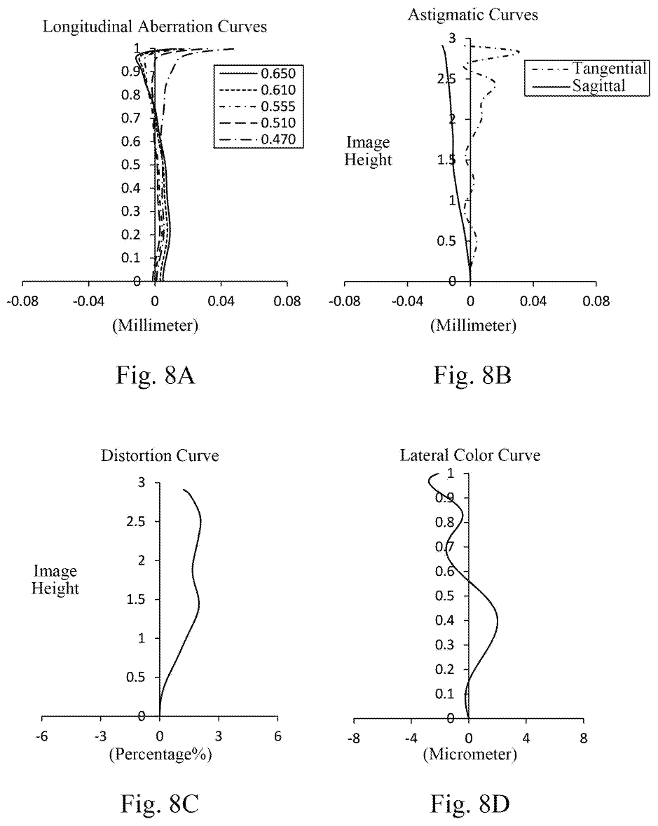

An optical imaging lens assembly according to example 4 of the present disclosure is described below with reference to FIG. 7 to FIG. 8D. FIG. 7 shows a schematic structural view of the optical imaging lens assembly according to example 4 of the present disclosure.

As shown in FIG. 7, the optical imaging lens assembly includes a stop STO, a first lens E1, a second lens E2, a third lens E3, a fourth lens E4, a fifth lens E5, an optical filter E6 and an imaging plane S12, which are sequentially arranged from an object side to an image side along an optical axis.

The first lens E1 has positive refractive power, an object-side surface S1 thereof is convex, and an image-side surface S2 thereof is convex. The second lens E2 has negative refractive power, an object-side surface S2 thereof is concave, and an image-side surface S3 thereof is concave. The third lens E3 has positive refractive power, an object-side surface S4 thereof is concave, and an image-side surface S5 thereof is convex. The fourth lens E4 has negative refractive power, an object-side surface S6 thereof is convex, and an image-side surface S7 thereof is concave. The fifth lens E5 has positive refractive power, an object-side surface S8 thereof is convex, and an image-side surface S9 thereof is concave. The optical filter E6 has an object-side surface S10 and an image-side surface S11. Light from an object sequentially passes through the respective surfaces S1 to S11 and is finally imaged on the imaging plane S12. In this example, the first lens and the second lens are combined into a cemented lens, and the image-side surface of the first lens is the object-side surface of the second lens.

In this example, a total effective focal length f of the optical imaging lens assembly satisfies f=3.42 mm, a distance TTL along the optical axis from the object-side surface S1 of the first lens E1 to the imaging plane S12 satisfies TTL=4.30 mm, half of a diagonal length ImgH of an effective pixel area on the imaging plane S12 satisfies ImgH=2.91 mm, half of a maximum field-of-view Semi-FOV of the optical imaging lens assembly satisfies Semi-FOV=40.1°, and an aperture number Fno of the optical imaging lens assembly satisfies Fno=2.04.

Table 7 is a table illustrating basic parameters of the optical imaging lens assembly of example 4, wherein the units for the radius of curvature, the thickness/distance and the focal length are millimeter (mm).

TABLE 7

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.2452 | | | | |
| S1 | Aspheric | 1.5187 | 0.6294 | 1.55 | 56.1 | 2.79 | −0.1142 |
| S2 | Aspheric | −88.6000 | 0.2000 | 1.68 | 19.2 | −9.25 | 90.5347 |
| S3 | Aspheric | 6.3561 | 0.3724 | | | | −99.0000 |
| S4 | Aspheric | −3.9499 | 0.5362 | 1.55 | 56.1 | 35.58 | 10.4888 |
| S5 | Aspheric | −3.4398 | 0.4296 | | | | 8.7948 |
| S6 | Aspheric | 59.8380 | 0.3774 | 1.68 | 19.2 | −7.69 | −99.0000 |
| S7 | Aspheric | 4.7810 | 0.0956 | | | | 3.2694 |
| S8 | Aspheric | 1.2411 | 0.7330 | 1.55 | 56.1 | 16.98 | −5.7034 |
| S9 | Aspheric | 1.1340 | 0.4464 | | | | −0.8097 |
| S10 | Spherical | Infinite | 0.2100 | 1.52 | 64.2 | | |
| S11 | Spherical | Infinite | 0.2700 | | | | |
| S12 | Spherical | Infinite | | | | | |

In example 4, the object-side surface and the image-side surface of any one of the first lens E1 to the fifth lens E5 are aspheric. Table 8 below shows high-order coefficients A4, A6, A8, A10, A12, A14, A16, A18 and A20 applicable to each aspheric surface S1 to S9 in example 4.

TABLE 8

| Surface | | | | | | | | | |
|---|---|---|---|---|---|---|---|---|---|
| number | A4 | A6 | A8 | A10 | A12 | A14 | A16 | A18 | A20 |
| S1 | −1.7039E−02 | 3.4231E−01 | −2.9593E+00 | 1.5455E+01 | −5.0180E+01 | 1.0204E+02 | −1.2627E+02 | 8.6902E+01 | −2.5495E+01 |
| S2 | −5.5507E−02 | −6.9129E−01 | 7.1840E+00 | −4.3516E+01 | 1.5680E+02 | −3.4677E+02 | 4.6130E+02 | −3.3856E+02 | 1.0510E+02 |
| S3 | 1.3187E−02 | −6.6716E−02 | −5.5914E−02 | −3.1642E−01 | 3.1032E+00 | −1.0998E+01 | 1.9457E+01 | −1.7344E+01 | 6.1549E+00 |
| S4 | −8.0566E−02 | −4.4619E−01 | 2.1878E+00 | −9.3775E+00 | 2.7708E+01 | −5.5157E+01 | 6.9217E+01 | −4.8396E+01 | 1.4142E+01 |
| S5 | 2.8584E−02 | −4.8797E−01 | 1.8371E+00 | −5.6233E+00 | 1.2395E+01 | −1.7594E+01 | 1.5312E+01 | −7.3739E+00 | 1.5102E+00 |
| S6 | 3.1469E−01 | −6.9128E−01 | 1.1325E+00 | −1.6386E+00 | 1.6101E+00 | −9.9447E−01 | 3.6258E−01 | −6.9610E−02 | 5.2806E−03 |
| S7 | −1.6954E−01 | 6.5057E−01 | −1.1234E+00 | 1.0334E+00 | −5.8639E−01 | 2.1086E−01 | −4.6615E−02 | 5.7681E−03 | −3.0565E−04 |
| S8 | −4.7791E−01 | 6.2094E−01 | −5.9335E−01 | 3.6761E−01 | −1.4250E−01 | 3.4576E−02 | −5.1256E−03 | 4.2579E−04 | −1.5226E−05 |
| S9 | −4.3127E−01 | 3.0357E−01 | −1.7539E−01 | 6.6163E−02 | −1.5886E−02 | 2.4216E−03 | −2.3301E−04 | 1.3578E−05 | −3.9146E−07 |

FIG. 8A illustrates longitudinal aberration curves of the optical imaging lens assembly according to example 4, representing the deviations of focal points converged by light of different wavelengths after passing through the lens assembly. FIG. 8B illustrates astigmatic curves of the optical imaging lens assembly according to example 4, representing the curvatures of a tangential plane and the curvatures of a sagittal plane. FIG. 8C illustrates a distortion curve of the optical imaging lens assembly according to example 4, representing the amounts of distortion corresponding to different image heights. FIG. 8D illustrates a lateral color curve of the optical imaging lens assembly according to example 4, representing the deviations of different image heights on an imaging plane after light passes through the lens assembly. It can be seen from FIG. 8A to FIG. 8D that the optical imaging lens assembly provided in example 4 may achieve good image quality.

### Example 5

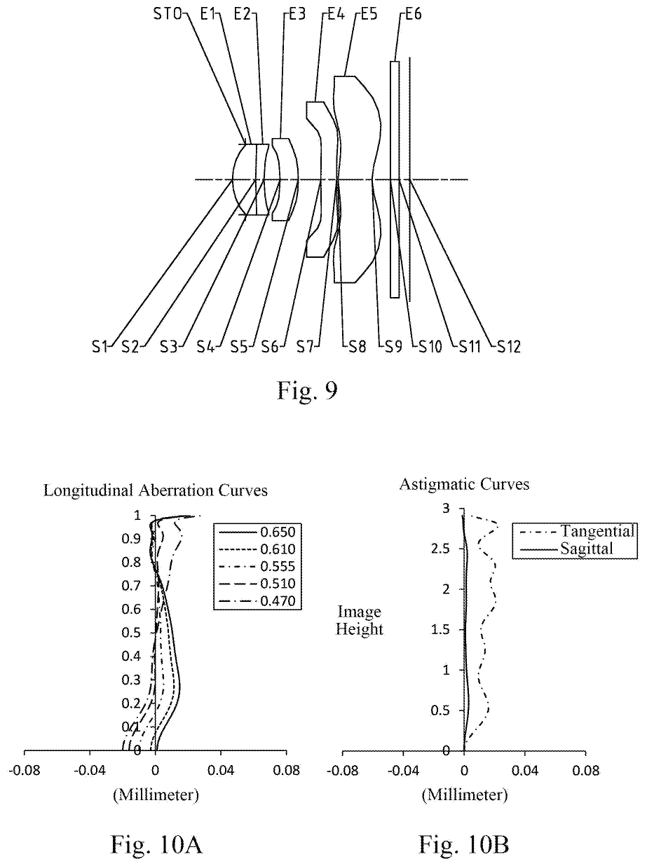

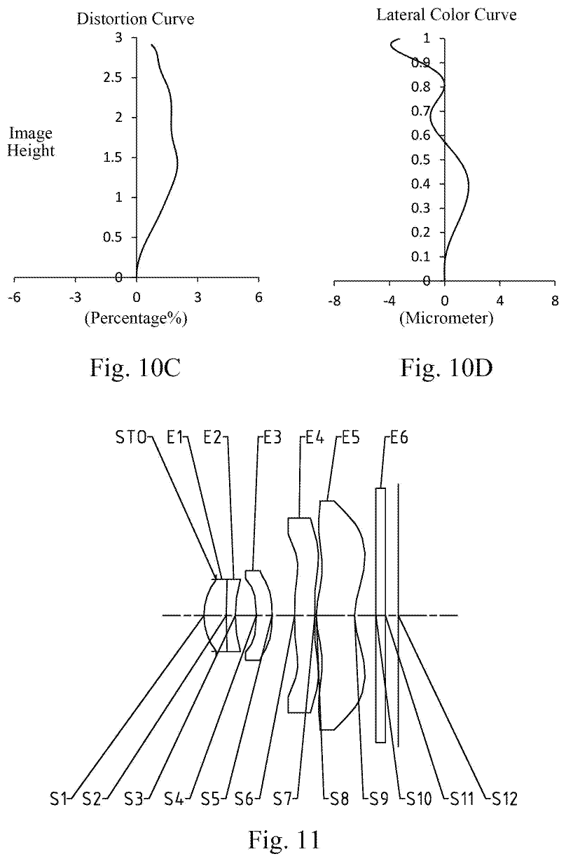

An optical imaging lens assembly according to example 5 of the present disclosure is described below with reference to FIG. 9 to FIG. 10D. FIG. 9 shows a schematic structural view of the optical imaging lens assembly according to example 5 of the present disclosure.

As shown in FIG. 9, the optical imaging lens assembly includes a stop STO, a first lens E1, a second lens E2, a third lens E3, a fourth lens E4, a fifth lens E5, an optical filter E6 and an imaging plane S12, which are sequentially arranged from an object side to an image side along an optical axis.

The first lens E1 has positive refractive power, an object-side surface S1 thereof is convex, and an image-side surface S2 thereof is concave. The second lens E2 has negative refractive power, an object-side surface S2 thereof is convex, and an image-side surface S3 thereof is concave. The third lens E3 has positive refractive power, an object-side surface S4 thereof is concave, and an image-side surface S5 thereof is convex. The fourth lens E4 has negative refractive power, an object-side surface S6 thereof is concave, and an image-side surface S7 thereof is convex. The fifth lens E5 has positive refractive power, an object-side surface S8 thereof is convex, and an image-side surface S9 thereof is concave. The optical filter E6 has an object-side surface S10 and an image-side surface S11. Light from an object sequentially passes through the respective surfaces S1 to S11 and is finally imaged on the imaging plane S12. In this example, the first lens and the second lens are combined into a cemented lens, and the image-side surface of the first lens is the object-side surface of the second lens.

In this example, a total effective focal length f of the optical imaging lens assembly satisfies f=3.45 mm, a distance TTL along the optical axis from the object-side surface S1 of the first lens E1 to the imaging plane S12 satisfies TTL=4.26 mm, half of a diagonal length ImgH of an effective pixel area on the imaging plane S12 satisfies ImgH=2.91 mm, half of a maximum field-of-view Semi-FOV of the optical imaging lens assembly satisfies Semi-FOV=39.9°, and an aperture number Fno of the optical imaging lens assembly satisfies Fno=2.04.

Table 9 is a table illustrating basic parameters of the optical imaging lens assembly of example 5, wherein the units for the radius of curvature, the thickness/distance and the focal length are millimeter (mm).

TABLE 9

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.3117 | | | | |
| S1 | Aspheric | 1.3434 | 0.5560 | 1.55 | 56.1 | 2.35 | 0.0950 |
| S2 | Aspheric | 5.6710 | 0.2000 | 1.68 | 19.2 | −5.45 | 6.3480 |
| S3 | Aspheric | 3.2669 | 0.3846 | | | | 1.1225 |
| S4 | Aspheric | −4.0110 | 0.4358 | 1.55 | 56.1 | 24.02 | 16.6361 |
| S5 | Aspheric | −3.1894 | 0.5404 | | | | 8.6503 |
| S6 | Aspheric | −7.2813 | 0.3793 | 1.68 | 19.2 | −11.72 | 21.1808 |
| S7 | Aspheric | −89.5424 | 0.0300 | | | | −29.1648 |
| S8 | Aspheric | 1.5222 | 0.8161 | 1.55 | 56.1 | 99.98 | −10.6714 |
| S9 | Aspheric | 1.2693 | 0.4397 | | | | −1.1961 |
| S10 | Spherical | Infinite | 0.2100 | 1.52 | 64.2 | | |
| S11 | Spherical | Infinite | 0.2633 | | | | |
| S12 | Spherical | Infinite | | | | | |

In example 5, the object-side surface and the image-side surface of any one of the first lens E1 to the fifth lens E5 are aspheric. Table 10 below shows high-order coefficients A4, A6, A8, A10, A12, A14, A16, A18 and A20 applicable to each aspheric surface S1 to S9 in example 5.

TABLE 10

| Surface | | | | | | | | | |
|---|---|---|---|---|---|---|---|---|---|
| number | A4 | A6 | A8 | A10 | A12 | A14 | A16 | A18 | A20 |
| S1 | −1.2956E−02 | 3.5351E−01 | −2.8916E+00 | 1.5038E+01 | −4.8743E+01 | 9.9157E+01 | −1.2254E+02 | 8.4002E+01 | −2.4473E+01 |
| S2 | −1.4601E−01 | 3.5927E−01 | −2.8190E+00 | 1.0996E+01 | −2.1259E+01 | 1.4236E+01 | 1.6783E+01 | −3.2658E+01 | 1.4767E+01 |
| S3 | −1.7008E−03 | 4.6114E−02 | −4.7085E−01 | 3.2502E+00 | −1.4788E+01 | 4.4443E+01 | −8.0728E+01 | 7.9947E+01 | −3.2455E+01 |
| S4 | −1.3579E−01 | 1.9462E−01 | −4.0326E+00 | 2.6605E+01 | −1.0332E+02 | 2.4638E+02 | −3.5649E+02 | 2.8893E+02 | −1.0023E+02 |
| S5 | −3.1189E−02 | −3.0814E−01 | 1.2019E+00 | −4.4560E+00 | 1.1973E+01 | −2.0178E+01 | 2.0526E+01 | −1.1407E+01 | 2.7043E+00 |
| S6 | 3.9099E−01 | −7.2737E−01 | 9.9867E−01 | −1.2412E+00 | 1.1129E+00 | −6.6310E−01 | 2.4365E−01 | −4.8532E−02 | 3.9210E−03 |
| S7 | 5.9093E−03 | 3.3716E−01 | −7.1741E−01 | 6.9803E−01 | −4.1322E−01 | 1.5568E−01 | −3.6137E−02 | 4.6894E−03 | −2.5976E−04 |
| S8 | −3.0178E−01 | 3.1451E−01 | −2.6604E−01 | 1.5550E−01 | −5.7755E−02 | 1.3482E−02 | −1.9274E−03 | 1.5479E−04 | −5.3665E−06 |
| S9 | −3.2278E−01 | 2.1318E−01 | −1.0701E−01 | 3.2950E−02 | −5.1433E−03 | 1.1010E−04 | 8.3742E−05 | −1.1277E−05 | 4.5886E−07 |

FIG. 10A illustrates longitudinal aberration curves of the optical imaging lens assembly according to example 5, representing the deviations of focal points converged by light of different wavelengths after passing through the lens assembly. FIG. 10B illustrates astigmatic curves of the optical imaging lens assembly according to example 5, representing the curvatures of a tangential plane and the curvatures of a sagittal plane. FIG. 10C illustrates a distortion curve of the optical imaging lens assembly according to example 5, representing the amounts of distortion corresponding to different image heights. FIG. 10D illustrates a lateral color curve of the optical imaging lens assembly according to example 5, representing the deviations of different image heights on an imaging plane after light passes through the lens assembly. It can be seen from FIG. 10A to FIG. 10D that the optical imaging lens assembly provided in example 5 may achieve good image quality.

### Example 6

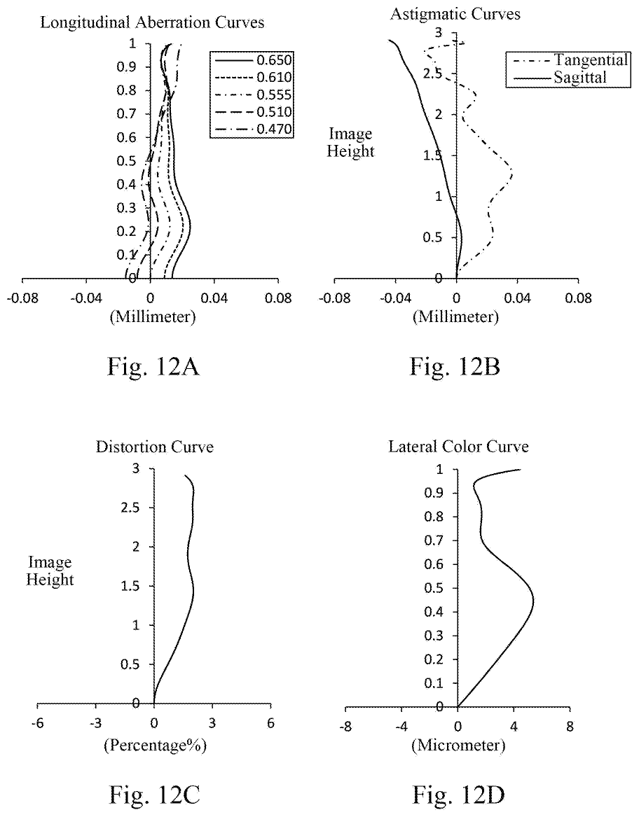

An optical imaging lens assembly according to example 6 of the present disclosure is described below with reference to FIG. 11 to FIG. 12D. FIG. 11 shows a schematic structural view of the optical imaging lens assembly according to example 6 of the present disclosure.

As shown in FIG. 11, the optical imaging lens assembly includes a stop STO, a first lens E1, a second lens E2, a third lens E3, a fourth lens E4, a fifth lens E5, an optical filter E6 and an imaging plane S12, which are sequentially arranged from an object side to an image side along an optical axis.

The first lens E1 has positive refractive power, an object-side surface S1 thereof is convex, and an image-side surface S2 thereof is concave. The second lens E2 has negative refractive power, an object-side surface S2 thereof is convex, and an image-side surface S3 thereof is concave. The third lens E3 has negative refractive power, an object-side surface S4 thereof is concave, and an image-side surface S5 thereof is convex. The fourth lens E4 has positive refractive power, an object-side surface S6 thereof is concave, and an image-side surface S7 thereof is convex. The fifth lens E5 has positive refractive power, an object-side surface S8 thereof is convex, and an image-side surface S9 thereof is concave. The optical filter E6 has an object-side surface S10 and an image-side surface S11. Light from an object sequentially passes through the respective surfaces S1 to S11 and is finally imaged on the imaging plane S12. In this example, the first lens and the second lens are combined into a cemented lens, and the image-side surface of the first lens is the object-side surface of the second lens.

In this example, a total effective focal length f of the optical imaging lens assembly satisfies f=3.26 mm, a distance TTL along the optical axis from the object-side surface S1 of the first lens E1 to the imaging plane S12 satisfies TTL=4.28 mm, half of a diagonal length ImgH of an effective pixel area on the imaging plane S12 satisfies ImgH=2.91 mm, half of a maximum field-of-view Semi-FOV of the optical imaging lens assembly satisfies Semi-FOV=41.3°, and an aperture number Fno of the optical imaging lens assembly satisfies Fno=2.04.

Table 11 is a table illustrating basic parameters of the optical imaging lens assembly of example 6, wherein the units for the radius of curvature, the thickness/distance and the focal length are millimeter (mm).

TABLE 11

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.2666 | | | | |
| S1 | Aspheric | 1.3672 | 0.4901 | 1.55 | 56.1 | 2.38 | 0.1284 |
| S2 | Aspheric | 5.4840 | 0.2000 | 1.68 | 19.2 | −5.34 | 2.1723 |
| S3 | Aspheric | 3.1994 | 0.4634 | | | | 0.7198 |
| S4 | Aspheric | −3.3881 | 0.3440 | 1.55 | 56.1 | −600.93 | 12.1947 |
| S5 | Aspheric | −3.5462 | 0.4951 | | | | 10.7291 |
| S6 | Aspheric | −13.6543 | 0.4438 | 1.68 | 19.2 | 37.36 | −99.0000 |
| S7 | Aspheric | −8.9861 | 0.0300 | | | | −81.8275 |
| S8 | Aspheric | 1.5905 | 0.8393 | 1.55 | 56.1 | 82.96 | −4.5137 |
| S9 | Aspheric | 1.3413 | 0.4687 | | | | −1.4536 |
| S10 | Spherical | Infinite | 0.2100 | 1.52 | 64.2 | | |
| S11 | Spherical | Infinite | 0.2922 | | | | |
| S12 | Spherical | Infinite | | | | | |

In example 6, the object-side surface and the image-side surface of any one of the first lens E1 to the fifth lens E5 are aspheric. Table 12 below shows high-order coefficients A4, A6, A8, A10, A12, A14, A16, A18 and A20 applicable to each aspheric surface S1 to S9 in example 6.

TABLE 12

| Surface | | | | | | | | | |
|---|---|---|---|---|---|---|---|---|---|
| number | A4 | A6 | A8 | A10 | A12 | A14 | A16 | A18 | A20 |
| S1 | −3.2047E−02 | 7.3935E−01 | −5.9045E+00 | 2.8944E+01 | −8.9396E+01 | 1.7599E+02 | −2.1399E+02 | 1.4651E+02 | −4.3201E+01 |
| S2 | −2.5821E−01 | 2.7431E+00 | −2.9479E+01 | 1.7486E+02 | −6.2133E+02 | 1.3626E+03 | −1.8069E+03 | 1.3292E+03 | −4.1616E+02 |
| S3 | −4.1846E−02 | 8.2483E−01 | −8.0370E+00 | 4.4448E+01 | −1.4817E+02 | 3.0639E+02 | −3.8533E+02 | 2.7121E+02 | −8.1925E+01 |
| S4 | −1.7401E−01 | −8.7740E−02 | −2.3856E+00 | 1.9344E+01 | −7.8734E+01 | 1.8639E+02 | −2.6473E+02 | 2.1307E+02 | −7.4562E+01 |
| S5 | −7.7707E−02 | −4.7682E−01 | 2.1908E+00 | −8.7933E+00 | 2.3465E+01 | −3.8457E+01 | 3.7464E+01 | −1.9655E+01 | 4.2978E+00 |
| S6 | 3.8425E−01 | −6.0930E−01 | 6.4771E−01 | −5.6524E−01 | 3.5177E−01 | −1.4213E−01 | 3.5125E−02 | −4.8106E−03 | 2.7926E−04 |
| S7 | 2.4003E−01 | −1.8711E−01 | 5.2303E−02 | −2.7038E−03 | −7.1677E−04 | −4.0689E−04 | 2.1622E−04 | −3.3823E−05 | 1.8178E−06 |
| S8 | −1.6795E−01 | 4.3187E−02 | 2.2408E−02 | −2.2894E−02 | 9.0477E−03 | −2.0018E−03 | 2.5738E−04 | −1.7949E−05 | 5.2423E−07 |
| S9 | −2.3929E−01 | 1.3118E−01 | −5.2697E−02 | 1.0641E−02 | 4.2004E−04 | −7.1133E−04 | 1.5037E−04 | −1.3687E−05 | 4.7341E−07 |

FIG. 12A illustrates longitudinal aberration curves of the optical imaging lens assembly according to example 6, representing the deviations of focal points converged by light of different wavelengths after passing through the lens assembly. FIG. 12B illustrates astigmatic curves of the optical imaging lens assembly according to example 6, representing the curvatures of a tangential plane and the curvatures of a sagittal plane. FIG. 12C illustrates a distortion curve of the optical imaging lens assembly according to example 6, representing the amounts of distortion corresponding to different image heights. FIG. 12D illustrates a lateral color curve of the optical imaging lens assembly according to example 6, representing the deviations of different image heights on an imaging plane after light passes through the lens assembly. It can be seen from FIG. 12A to FIG. 12D that the optical imaging lens assembly provided in example 6 may achieve good image quality.

### Example 7

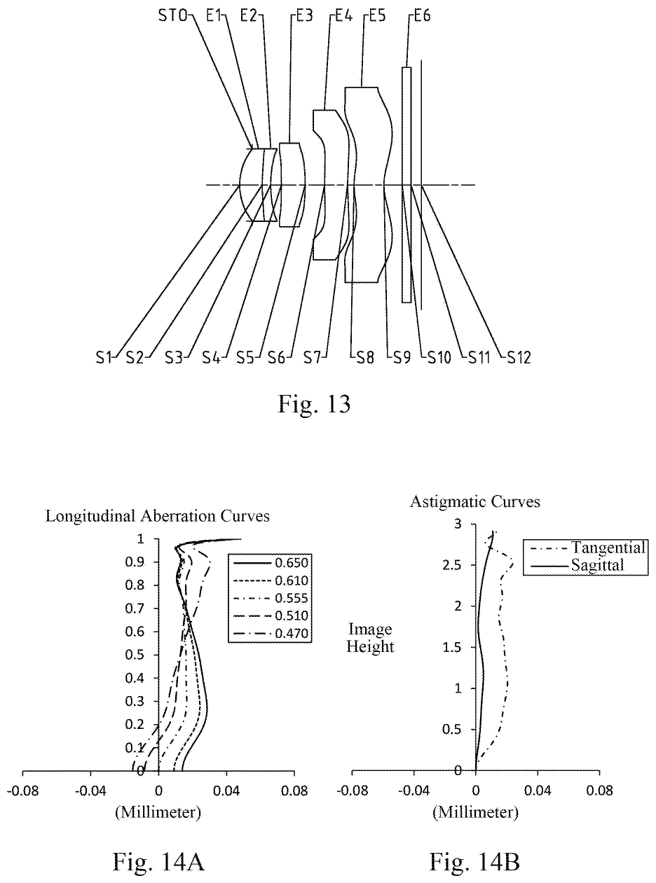

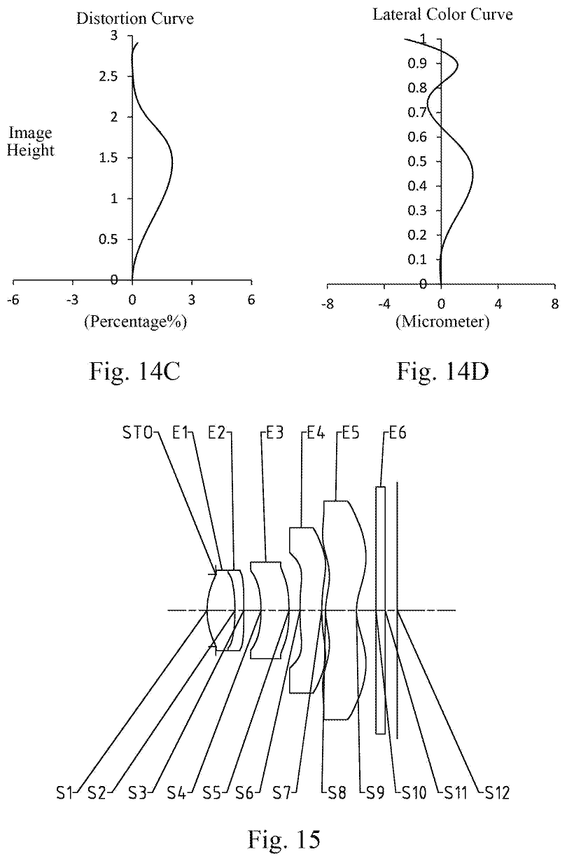

An optical imaging lens assembly according to example 7 of the present disclosure is described below with reference to FIG. 13 to FIG. 14D. FIG. 13 shows a schematic structural view of the optical imaging lens assembly according to example 7 of the present disclosure.

As shown in FIG. 13, the optical imaging lens assembly includes a stop STO, a first lens E1, a second lens E2, a third lens E3, a fourth lens E4, a fifth lens E5, an optical filter E6 and an imaging plane S12, which are sequentially arranged from an object side to an image side along an optical axis.

The first lens E1 has positive refractive power, an object-side surface S1 thereof is convex, and an image-side surface S2 thereof is concave. The second lens E2 has negative refractive power, an object-side surface S2 thereof is convex, and an image-side surface S3 thereof is concave. The third lens E3 has positive refractive power, an object-side surface S4 thereof is convex, and an image-side surface S5 thereof is convex. The fourth lens E4 has negative refractive power, an object-side surface S6 thereof is convex, and an image-side surface S7 thereof is concave. The fifth lens E5 has positive refractive power, an object-side surface S8 thereof is convex, and an image-side surface S9 thereof is concave. The optical filter E6 has an object-side surface S10 and an image-side surface S11. Light from an object sequentially passes through the respective surfaces S1 to S11 and is finally imaged on the imaging plane S12. In this example, the first lens and the second lens are combined into a cemented lens, and the image-side surface of the first lens is the object-side surface of the second lens.

In this example, a total effective focal length f of the optical imaging lens assembly satisfies f=3.47 mm, a distance TTL along the optical axis from the object-side surface S1 of the first lens E1 to the imaging plane S12 satisfies TTL=4.30 mm, half of a diagonal length ImgH of an effective pixel area on the imaging plane S12 satisfies ImgH=2.91 mm, half of a maximum field-of-view Semi-FOV of the optical imaging lens assembly satisfies Semi-FOV=39.8°, and an aperture number Fno of the optical imaging lens assembly satisfies Fno=2.04.

Table 13 is a table illustrating basic parameters of the optical imaging lens assembly of example 7, wherein the units for the radius of curvature, the thickness/distance and the focal length are millimeter (mm).

TABLE 13

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.2951 | | | | |
| S1 | Aspheric | 1.3893 | 0.5312 | 1.55 | 56.1 | 2.35 | 0.0376 |
| S2 | Aspheric | 3.4483 | 0.2000 | 1.68 | 19.2 | −4.64 | 1.3280 |
| S3 | Aspheric | 2.6582 | 0.2520 | | | | −0.9599 |
| S4 | Aspheric | 84.5350 | 0.5634 | 1.55 | 56.1 | 10.25 | −99.0000 |
| S5 | Aspheric | −5.9765 | 0.4581 | | | | 33.1663 |
| S6 | Aspheric | 13.5164 | 0.5417 | 1.68 | 19.2 | −8.71 | −49.7100 |
| S7 | Aspheric | 4.0411 | 0.1528 | | | | 3.4787 |
| S8 | Aspheric | 1.5104 | 0.7052 | 1.55 | 56.1 | 92.50 | −9.6879 |
| S9 | Aspheric | 1.3002 | 0.4311 | | | | −1.0772 |
| S10 | Spherical | Infinite | 0.2100 | 1.52 | 64.2 | | |
| S11 | Spherical | Infinite | 0.2546 | | | | |
| S12 | Spherical | Infinite | | | | | |

In example 7, the object-side surface and the image-side surface of any one of the first lens E1 to the fifth lens E5 are aspheric. Table 14 below shows high-order coefficients A4, A6, A8, A10, A12, A14, A16, A18 and A20 applicable to each aspheric surface S1 to S9 in example 7.

TABLE 14

| Surface | | | | | | | | | |
|---|---|---|---|---|---|---|---|---|---|
| number | A4 | A6 | A8 | A10 | A12 | A14 | A16 | A18 | A20 |
| S1 | −1.6871E−02 | 3.9238E−01 | −3.3753E+00 | 1.7664E+01 | −5.7073E+01 | 1.1499E+02 | −1.4033E+02 | 9.4811E+01 | −2.7194E+01 |
| S2 | −1.7709E−01 | −2.8157E−01 | 4.1076E+00 | −2.8064E+01 | 1.1239E+02 | −2.6667E+02 | 3.6962E+02 | −2.7405E+02 | 8.3271E+01 |
| S3 | −7.1703E−03 | −8.2186E−02 | 6.1051E−01 | −1.5901E+00 | −2.1817E+00 | 2.5579E+01 | −6.6102E+01 | 7.6521E+01 | −3.3708E+01 |
| S4 | −9.9828E−02 | 9.2313E−02 | −1.5842E+00 | 9.2782E+00 | −3.5326E+01 | 8.5933E+01 | −1.2834E+02 | 1.0762E+02 | −3.8098E+01 |
| S5 | −3.9488E−02 | −1.8605E−01 | 8.5766E−01 | −3.3291E+00 | 8.7586E+00 | −1.4663E+01 | 1.5212E+01 | −8.8508E+00 | 2.2444E+00 |
| S6 | 1.0506E−02 | −8.8188E−02 | 1.4504E−01 | −3.6495E−01 | 3.0126E−01 | 6.9220E−02 | −2.8526E−01 | 1.7537E−01 | −3.4587E−02 |
| S7 | −3.3038E−01 | 6.5195E−01 | −7.9755E−01 | 5.7185E−01 | −2.5350E−01 | 6.6153E−02 | −8.5087E−03 | 1.9752E−04 | 3.8842E−05 |
| S8 | −3.6561E−01 | 2.5322E−01 | −3.2043E−02 | −9.5187E−02 | 7.9481E−02 | −2.9296E−02 | 5.7437E−03 | −5.8068E−04 | 2.3669E−05 |
| S9 | −3.4670E−01 | 2.5576E−01 | −1.7082E−01 | 9.1128E−02 | −3.6315E−02 | 9.9093E−03 | −1.6936E−03 | 1.6122E−04 | −6.4881E−06 |

FIG. 14A illustrates longitudinal aberration curves of the optical imaging lens assembly according to example 7, representing the deviations of focal points converged by light of different wavelengths after passing through the lens assembly. FIG. 14B illustrates astigmatic curves of the optical imaging lens assembly according to example 7, representing the curvatures of a tangential plane and the curvatures of a sagittal plane. FIG. 14C illustrates a distortion curve of the optical imaging lens assembly according to example 7, representing the amounts of distortion corresponding to different image heights. FIG. 14D illustrates a lateral color curve of the optical imaging lens assembly according to example 7, representing the deviations of different image heights on an imaging plane after light passes through the lens assembly. It can be seen from FIG. 14A to FIG. 14D that the optical imaging lens assembly provided in example 7 may achieve good image quality.

### Example 8

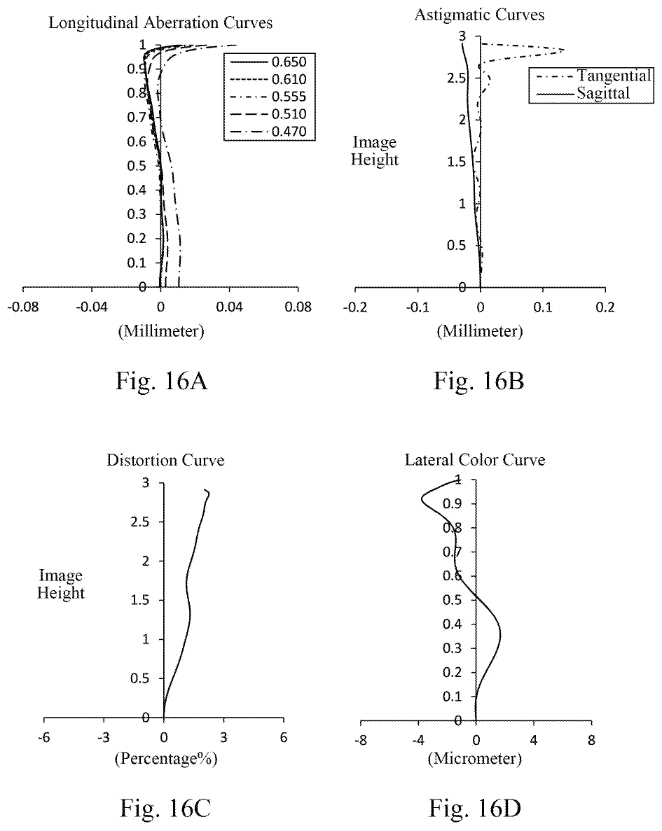

An optical imaging lens assembly according to example 8 of the present disclosure is described below with reference to FIG. 15 to FIG. 16D. FIG. 15 shows a schematic structural view of the optical imaging lens assembly according to example 8 of the present disclosure.

As shown in FIG. 15, the optical imaging lens assembly includes a stop STO, a first lens E1, a second lens E2, a third lens E3, a fourth lens E4, a fifth lens E5, an optical filter E6 and an imaging plane S12, which are sequentially arranged from an object side to an image side along an optical axis.

The first lens E1 has positive refractive power, an object-side surface S1 thereof is convex, and an image-side surface S2 thereof is convex. The second lens E2 has negative refractive power, an object-side surface S2 thereof is concave, and an image-side surface S3 thereof is convex. The third lens E3 has negative refractive power, an object-side surface S4 thereof is concave, and an image-side surface S5 thereof is convex. The fourth lens E4 has negative refractive power, an object-side surface S6 thereof is convex, and an image-side surface S7 thereof is concave. The fifth lens E5 has positive refractive power, an object-side surface S8 thereof is convex, and an image-side surface S9 thereof is concave. The optical filter E6 has an object-side surface S10 and an image-side surface S11. Light from an object sequentially passes through the respective surfaces S1 to S11 and is finally imaged on the imaging plane S12. In this example, the first lens and the second lens are combined into a cemented lens, and the image-side surface of the first lens is the object-side surface of the second lens.

In this example, a total effective focal length f of the optical imaging lens assembly satisfies f=3.35 mm, a distance TTL along the optical axis from the object-side surface S1 of the first lens E1 to the imaging plane S12 satisfies TTL=4.30 mm, half of a diagonal length ImgH of an effective pixel area on the imaging plane S12 satisfies ImgH=2.91 mm, half of a maximum field-of-view Semi-FOV of the optical imaging lens assembly satisfies Semi-FOV=40.5°, and an aperture number Fno of the optical imaging lens assembly satisfies Fno=2.04.

Table 15 is a table illustrating basic parameters of the optical imaging lens assembly of example 8, wherein the units for the radius of curvature, the thickness/distance and the focal length are millimeter (mm).

TABLE 15

| | | | | Material | | | |
|---|---|---|---|---|---|---|---|
| Surface | Surface | Radius of | Thickness/ | Refractive | Abbe | Focal | Conic |
| number | type | curvature | Distance | index | number | length | coefficient |
| OBJ | Spherical | Infinite | Infinite | | | | |
| STO | Spherical | Infinite | −0.1978 | | | | |
| S1 | Aspheric | 1.6491 | 0.6339 | 1.55 | 56.1 | 3.29 | −0.4368 |
| S2 | Aspheric | −4.2645 | 0.2000 | 1.68 | 19.2 | −44.72 | −28.0707 |
| S3 | Aspheric | −80.0000 | 0.3896 | | | | −99.0000 |
| S4 | Aspheric | −3.1655 | 0.6358 | 1.55 | 56.1 | −166.35 | 8.2941 |
| S5 | Aspheric | −3.5125 | 0.2471 | | | | 8.3671 |
| S6 | Aspheric | 17.2333 | 0.4916 | 1.68 | 19.2 | −8.37 | −99.0000 |
| S7 | Aspheric | 4.2168 | 0.0847 | | | | 3.5963 |
| S8 | Aspheric | 1.2734 | 0.6987 | 1.55 | 56.1 | 37.05 | −3.3856 |
| S9 | Aspheric | 1.0956 | 0.4425 | | | | −0.8642 |
| S10 | Spherical | Infinite | 0.2100 | 1.52 | 64.2 | | |
| S11 | Spherical | Infinite | 0.2661 | | | | |
| S12 | Spherical | Infinite | | | | | |

In example 8, the object-side surface and the image-side surface of any one of the first lens E1 to the fifth lens E5 are aspheric. Table 16 below shows high-order coefficients A4, A6, A8, A10, A12, A14, A16, A18 and A20 applicable to each aspheric surface S1 to S9 in example 8.

TABLE 16

| Surface | | | | | | | | | |
|---|---|---|---|---|---|---|---|---|---|
| number | A4 | A6 | A8 | A10 | A12 | A14 | A16 | A18 | A20 |
| S1 | −2.4094E−02 | 3.5965E−01 | −3.1577E+00 | 1.6041E+01 | −5.0820E+01 | 1.0112E+02 | −1.2304E+02 | 8.3656E+01 | −2.4344E+01 |
| S2 | −2.5704E−03 | −1.5944E+00 | 1.6109E+01 | −9.2970E+01 | 3.2434E+02 | −7.0156E+02 | 9.1784E+02 | −6.6403E+02 | 2.0306E+02 |
| S3 | −5.6140E−02 | −3.0146E−02 | −9.3243E−02 | 8.1376E−02 | 4.5320E−01 | −2.6666E+00 | 5.7705E+00 | −5.8079E+00 | 2.2096E+00 |
| S4 | −5.2867E−02 | −4.8606E−01 | 2.9339E+00 | −1.2847E+01 | 3.7727E+01 | −7.1711E+01 | 8.4884E+01 | −5.6375E+01 | 1.5902E+01 |
| S5 | 1.2618E−01 | −8.9623E−01 | 2.3404E+00 | −4.6519E+00 | 7.5374E+00 | −8.7579E+00 | 6.6336E+00 | −2.8648E+00 | 5.3286E−01 |
| S6 | 3.9608E−01 | −1.2036E+00 | 1.9642E+00 | −2.3618E+00 | 1.7792E+00 | −6.5437E−01 | −2.0096E−02 | 9.2533E−02 | −2.0041E−02 |
| S7 | 1.7137E−03 | 5.6320E−02 | −2.9231E−01 | 3.4855E−01 | −2.2608E−01 | 9.0193E−02 | −2.1983E−02 | 2.9959E−03 | −1.7491E−04 |
| S8 | −5.1398E−01 | 5.5635E−01 | −4.7873E−01 | 2.9052E−01 | −1.1290E−01 | 2.7470E−02 | −4.0623E−03 | 3.3468E−04 | −1.1806E−05 |
| S9 | −4.7078E−01 | 3.5785E−01 | −2.3006E−01 | 1.0271E−01 | −3.0067E−02 | 5.6001E−03 | −6.3529E−04 | 3.9830E−05 | −1.0544E−06 |

FIG. 16A illustrates longitudinal aberration curves of the optical imaging lens assembly according to example 8, representing the deviations of focal points converged by light of different wavelengths after passing through the lens assembly. FIG. 16B illustrates astigmatic curves of the optical imaging lens assembly according to example 8, representing the curvatures of a tangential plane and the curvatures of a sagittal plane. FIG. 16C illustrates a distortion curve of the optical imaging lens assembly according to example 8, representing the amounts of distortion corresponding to different image heights. FIG. 16D illustrates a lateral color curve of the optical imaging lens assembly according to example 8, representing the deviations of different image heights on an imaging plane after light passes through the lens assembly. It can be seen from FIG. 16A to FIG. 16D that the optical imaging lens assembly provided in example 8 may achieve good image quality.

In view of the above, examples 1 to 8 respectively satisfy the relationship shown in Table 17.

TABLE 17

| Conditional/Example | 1 | 2 | 3 | 4 | 5 | 6 | 7 | 8 |
|---|---|---|---|---|---|---|---|---|
| f1/R1 | 1.75 | 1.75 | 1.76 | 1.84 | 1.75 | 1.74 | 1.69 | 1.99 |
| (CT1 + CT2)/CT3 | 1.75 | 1.69 | 1.67 | 1.5 | 1.73 | 2.01 | 1.30 | 1.31 |
| CT5/CT4 | 1.62 | 1.50 | 2.0 | 1.94 | 2.15 | 1.89 | 1.30 | 1.42 |
| T34/T23 | 1.35 | 1.5 | 0.91 | 1.15 | 1.41 | 1.07 | 1.82 | 0.63 |
| DT51/DT11 | 2.8 | 2.76 | 2.69 | 2.60 | 2.64 | 3.06 | 2.30 | 2.71 |
| (CT1 + CT2)/(ET1 + ET2) | 1.38 | 1.38 | 1.42 | 1.43 | 1.38 | 1.32 | 1.27 | 1.56 |
| R6/f | −1.00 | −0.92 | −1.35 | −1.01 | −0.92 | −1.09 | −1.72 | −1.05 |
| R9/R10 | 1.08 | 1.12 | 0.94 | 1.09 | 1.20 | 1.19 | 1.16 | 1.16 |
| f12/f | 1.10 | 1.11 | 1.06 | 1.08 | 1.12 | 1.25 | 1.32 | 0.96 |
| (DT11 + DT22)/2 (mm) | 0.81 | 0.82 | 0.83 | 0.86 | 0.82 | 0.79 | 0.84 | 0.87 |

The present disclosure further provides an imaging apparatus, having an electronic photosensitive element which may be a photosensitive Charge-Coupled Device (CCD) or a Complementary Metal-Oxide Semiconductor (CMOS). The imaging apparatus may be an independent imaging device such as a digital camera, or may be an imaging module integrated in a mobile electronic device such as a mobile phone. The imaging apparatus is equipped with the optical imaging lens assembly described above.

The foregoing is only a description of the preferred examples of the present disclosure and the applied technical principles. It should be appreciated by those skilled in the art that the inventive scope of the present disclosure is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present disclosure with (but not limited to), technical features with similar functions.

What is claimed is:

1. An optical imaging lens assembly, sequentially from an object side to an image side of the optical imaging lens assembly along an optical axis, comprising:
a first lens having positive refractive power;
a second lens having negative refractive power and an aspheric image-side surface;
a third lens having refractive power and a convex image-side surface;
a fourth lens having refractive power; and
a fifth lens having positive refractive power, a convex object-side surface and a concave image-side surface,
wherein the first lens and the second lens are cemented to form a cemented lens.

2. The optical imaging lens assembly according to claim 1, wherein 1.5<f1/R1<2.0,
where f1 is an effective focal length of the first lens, and R1 is a radius of curvature of an object-side surface of the first lens.

3. The optical imaging lens assembly according to claim 1, wherein 0.5<f12/f<1.5,
where f12 is a combined focal length of the first lens and the second lens, and f is a total effective focal length of the optical imaging lens assembly.

4. The optical imaging lens assembly according to claim 1, wherein 1.0<(CT1+CT2)/CT3≤2.01,
where CT1 is a center thickness of the first lens along the optical axis, CT2 is a center thickness of the second lens along the optical axis, and CT3 is a center thickness of the third lens along the optical axis.

5. The optical imaging lens assembly according to claim 1, wherein 1.0<CT5/CT4<2.5,
where CT5 is a center thickness of the fifth lens along the optical axis, and CT4 is a center thickness of the fourth lens along the optical axis.

6. The optical imaging lens assembly according to claim 1, wherein 0.5<T34/T23<2.0,
where T34 is a spaced interval between the third lens and the fourth lens along the optical axis, and T23 is a spaced interval between the second lens and the third lens along the optical axis.

7. The optical imaging lens assembly according to claim 1, wherein 2.0<DT51/DT11<3.5,
where DT51 is a maximum effective radius of the object-side surface of the fifth lens, and DT11 is a maximum effective radius of an object-side surface of the first lens.

8. The optical imaging lens assembly according to claim 1, wherein 1.0<(CT1+CT2)/(ET1+ET2)<2.0,
where CT1 is a center thickness of the first lens along the optical axis, CT2 is a center thickness of the second lens along the optical axis, ET1 is an edge thickness of the first lens, and ET2 is an edge thickness of the second lens.

9. The optical imaging lens assembly according to claim 1, wherein −2.0<R6/f<−0.5,
where R6 is a radius of curvature of the image-side surface of the third lens, and f is a total effective focal length of the optical imaging lens assembly.

10. The optical imaging lens assembly according to claim 1, wherein 0.5<R9/R10<1.5,
where R9 is a radius of curvature of the object-side surface of the fifth lens, and R10 is a radius of curvature of the image-side surface of the fifth lens.

11. The optical imaging lens assembly according to claim 8, wherein (DT11+DT22)/2<0.9 mm,
where DT11 is a maximum effective radius of an object-side surface of the first lens, and DT22 is a maximum effective radius of the image-side surface of the second lens.

12. The optical imaging lens assembly according to claim 1, wherein each of the first to the fifth lenses is made of plastic material.

13. An optical imaging lens assembly, sequentially from an object side to an image side of the optical imaging lens assembly along an optical axis, comprising:
a first lens having positive refractive power;
a second lens having negative refractive power and an aspheric image-side surface;
a third lens having refractive power and a convex image-side surface;
a fourth lens having refractive power; and
a fifth lens having positive refractive power, a convex object-side surface and a concave image-side surface,
wherein (DT11+DT22)/2<0.9 mm,
where DT11 is a maximum effective radius of an object-side surface of the first lens, and DT22 is a maximum effective radius of the image-side surface of the second lens.

14. The optical imaging lens assembly according to claim 13, wherein 0.5<f12/f<1.5,
where f12 is a combined focal length of the first lens and the second lens, and f is a total effective focal length of the optical imaging lens assembly.

15. The optical imaging lens assembly according to claim 13, wherein 1.0<(CT1+CT2)/CT3<2.01,
where CT1 is a center thickness of the first lens along the optical axis, CT2 is a center thickness of the second lens along the optical axis, and CT3 is a center thickness of the third lens along the optical axis.

16. The optical imaging lens assembly according to claim 13, wherein 1.0<CT5/CT4<2.5,
where CT5 is a center thickness of the fifth lens along the optical axis, and CT4 is a center thickness of the fourth lens along the optical axis.

17. The optical imaging lens assembly according to claim 13, wherein 0.5<T34/T23<2.0,
where T34 is a spaced interval between the third lens and the fourth lens along the optical axis, and T23 is a spaced interval between the second lens and the third lens along the optical axis.

18. The optical imaging lens assembly according to claim 13, wherein 2.0<DT51/DT11<3.5,
where DT51 is a maximum effective radius of the object-side surface of the fifth lens, and DT11 is the maximum effective radius of the object-side surface of the first lens.

19. The optical imaging lens assembly according to claim 13, wherein 1.0<(CT1+CT2)/(ET1+ET2)<2.0,
where CT1 is a center thickness of the first lens along the optical axis, CT2 is a center thickness of the second lens along the optical axis, ET1 is an edge thickness of the first lens, and ET2 is an edge thickness of the second lens.

20. The optical imaging lens assembly according to claim 13, wherein 1.5<f1/R1<2.0,
where f1 is an effective focal length of the first lens, and R1 is a radius of curvature of the object-side surface of the first lens.
